(19) United States
(12) Patent Application Publication
(10) Pub. No.: US 2012/0309373 A1
(43) Pub. Date: Dec. 6, 2012

(54) Proximity-Based Application Activation

(75) Inventor: Ahmed Abogendia, Randolph, NJ (US)

(73) Assignee: ATLANTA TRADING & ENG CONSULTING LLC, Parsippany, NJ (US)

(21) Appl. No.: 13/484,704

(22) Filed: May 31, 2012

Related U.S. Application Data
(60) Provisional application No. 61/492,120, filed on Jun. 1, 2011.

(51) Int. Cl. H04W 4/16

(52) U.S. Cl. 455/417

(57) ABSTRACT

An application is caused to be executed on a computing device in response to a particular mobile computing device entering a range of a particular wireless source. One example of an application that is executed is a call forwarding application for directing voice calls intended for the mobile computing device coupled to a cellular network to a land line network such that a user may receive calls at a telephone connected to the land line network. In another example, when the mobile computing device is within range of a particular wireless source, an electronic device (e.g., light, heating system, air conditioner) may be activated by the application that is executed. In still another example, the executing application may cause data that is stored on the mobile computing device to be transferred to the computing device.

### PRIORITY CLAIM

This application claims the priority benefit under 35 U.S.C. §119(e) of provisional Patent Application No. 61/492,120, filed Jun. 1, 2011 and incorporated herein in its entirety.

### BACKGROUND

The use of mobile computing devices has increased rapidly over the past decade resulting in an increase in the amount of data that is transferred over cellular networks. In order to reduce the strain on cellular networks due to increased data transfer, telecommunications companies seek to reduce traffic at key points in the network where a bottleneck may occur. For example, the network traffic may be off-loaded to a wireless local network such as Wi-Fi in order to reduce the load at base stations in the cellular network.

U.S. Pat. No. 7,106,848, issued on Sep. 12, 2006 and incorporated by reference herein, discloses a method and apparatus for in-progress call forwarding. Calls are transferred between a mobile telephone and a land-based phone in response to user input. The user may request the transfer in order to access the call on a more convenient device. While a transfer from the mobile telephone to the land-based phone would reduce traffic on the cellular network, the '848 patent requires the user to request manually each individual call transfer.

U.S. Patent Publication No. 2005/0215243, published on Sep. 29, 2005 and incorporated by reference herein, discloses automatic mobile call forwarding with time-based and location-based trigger events. A cellular phone determines when the time- and location-based trigger events are satisfied by a current time and a current location of the cellular phone. When the trigger events are satisfied, a cellular service provider is notified to forward subsequent calls to a target number. Since the target number may be associated with a land-based phone, traffic on the cellular network may be reduced. However, the current location of the cellular phone is determined based on global positioning system (GPS) technology such that the location-based trigger event must be strictly defined within a target area that is accessible by GPS.

### SUMMARY

Aspects of the present disclosure relate generally to proximity-based application activation and particularly to the execution of a computer-based application in response to a particular wireless source detecting a particular mobile computing device.

The geographic location of a user's mobile computing device may be detected by the presence of a wireless source (e.g., Wi-Fi or Bluetooth). In response to the mobile computing device sensing a particular wireless source, a computing device coupled to the wireless source executes a particular application. The application may be pre-identified to execute when the mobile computing device is within range of the wireless source.

In one illustrative example, a user configures a forwarding application on her mobile telephone to have all calls intended for the mobile telephone to be directed to an office telephone connected to a land line network when the mobile telephone is within range of a specific wireless source such as a Wi-Fi network located in her office. When the user enters her office with her mobile telephone and the mobile telephone detects the Wi-Fi network, all calls intended for the mobile telephone are directed to the user's office telephone. Accordingly, when the mobile telephone is in the vicinity of the Wi-Fi network, voice calls intended to be received at the mobile telephone are redirected to the land line telephone. As long as the mobile telephone remains in the zone of the Wi-Fi network, all voice calls will be directed to the telephone connected to the land line. Once the mobile telephone is removed from the Wi-Fi network zone, the user will receive calls at her mobile telephone in accordance with normal operating conditions.

In another illustrative example, a user configures an application on his mobile computing device to have a heating/air conditioning system to be activated in an area when the user's mobile computing device is detected by a wireless source to be proximate the area. In this case, the user need not manually activate the heating/air conditioning system because the system is automatically activated by virtue of the device being within range of the wireless source.

In one aspect, a computer-implemented method includes identifying a location of a mobile computing device within range of a wireless source. A message that includes a land line telephone number where voice calls are to be forwarded is received from the mobile computing device. A voice call intended for the mobile computing device is forwarded to a telephone coupled to a land line network based on the land line telephone number.

In another aspect, a mobile computing device includes a processor configured to execute a call forwarding application. The executed call forwarding application causing the processor to: 1) identify that the mobile computing device is within range of a wireless source; and 2) send a message to a location register. The message includes a land line telephone number where a voice call intended for the mobile computing device is to be forwarded.

In another aspect, a system includes a telephone coupled to a central telecommunications office by a land line network and a mobile computing device coupled to a mobile switching center by a base station. The mobile computing device is positioned within range of a wireless source provided proximate the telephone. The mobile switching center is coupled to the central telecommunications office, and the mobile switching center includes a location register. The location register associates a first number identifying the telephone with a second number identifying the mobile computing device. A voice call directed to the mobile computing device at the second number is redirected to the telephone at the first number.

In another aspect a computer-implemented method includes receiving, at a computing device, a signal from a wireless source that a mobile computing device is within range of the wireless source. The signal includes an identifier of the mobile computing device and an identifier of the wireless source. An application associated with the mobile computing device and the wireless source is identified. The application is stored on the computing device and is identified using the identifier of the mobile computing device and the identifier of the wireless source. The application is executed on the computing device.

### BRIEF DESCRIPTION OF THE DRAWINGS

FIG. 1 is a functional diagram of a system in accordance with example embodiments.

FIG. 2 is a pictorial diagram of the system of FIG. 1.

FIG. 3 is a pictorial diagram of a system in accordance with example embodiments.

FIG. 4 is a flow diagram in accordance with example embodiments.

FIG. 5 is a pictorial diagram of a system in accordance with example embodiments.

FIG. 6 is a flow diagram in accordance with example embodiments.

### DETAILED DESCRIPTION

Aspects of the present disclosure relate generally to causing an application to be executed on a computing device in response to a mobile computing device entering a range of a wireless source. The geographic location of the mobile computing device may be detected by the presence of the wireless source (e.g., Wi-Fi or Bluetooth). When the mobile computing device senses a particular wireless source, a particular application is activated. For example, a user may approach a dark building. When a wireless source from the building senses the user's mobile computing device, a computing device coupled to the wireless source may be activated to cause a light to turn on at an entrance to the building.

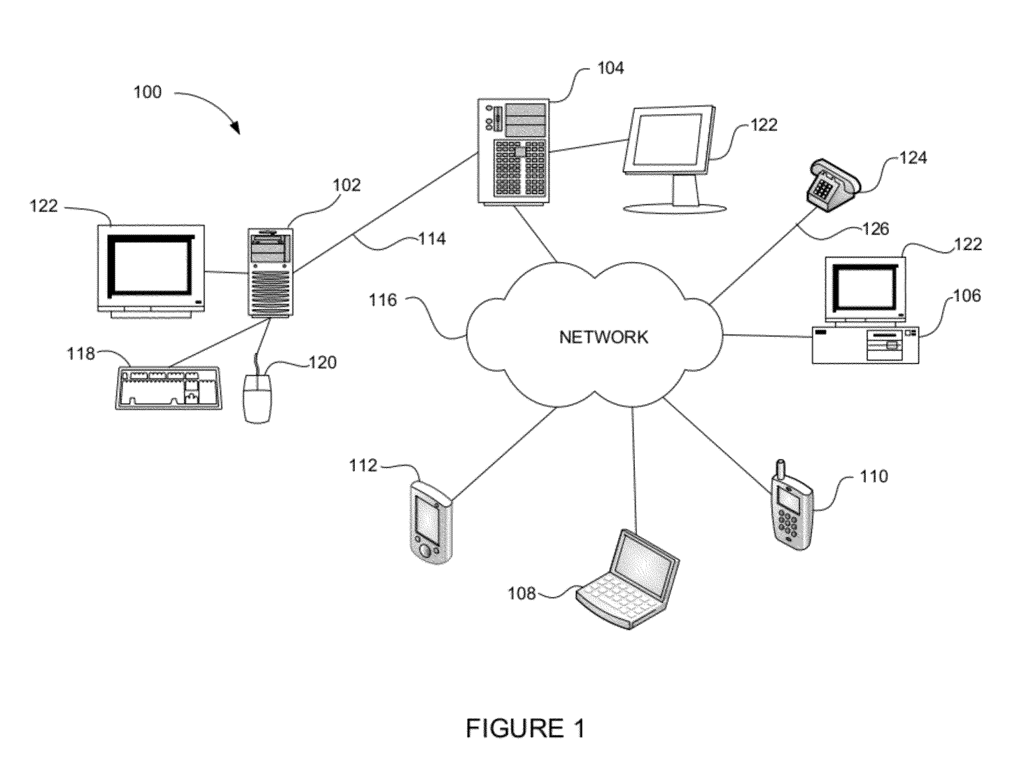

FIG. 1 presents a schematic diagram of a computer system depicting various computing devices that can be used alone or in a networked configuration in accordance with aspects of the disclosure. For example, this figure illustrates a computer network 100 having a plurality of computers 102, 104, 106, 108 as well as other types of devices such as mobile computing devices including a mobile phone 110 and a PDA 112. The computers 102, 104, 106, 108 and mobile computing devices 110, 112 may be interconnected via a local or direct connection 114 and/or may be coupled via a network 116 such as a LAN, WAN, the Internet, etc., which may be wired or wireless. A telephone 124 may be coupled to the network 116 via a land line 126.

Each computing device may include, for example, one or more processing devices and have user inputs such as a keyboard 118 and mouse 120 and/or various other types of input devices such as pen-inputs, joysticks, buttons, touch screens, etc., as well as a display 122, which could include, for instance, a CRT, LCD, plasma screen monitor, TV, projector, etc. Each computer 102, 104, 106, 108 may be a personal computer, server, etc. By way of example only, computers 102, 106 may be personal computers while computer 104 may be a server and computer 108 may be a laptop.

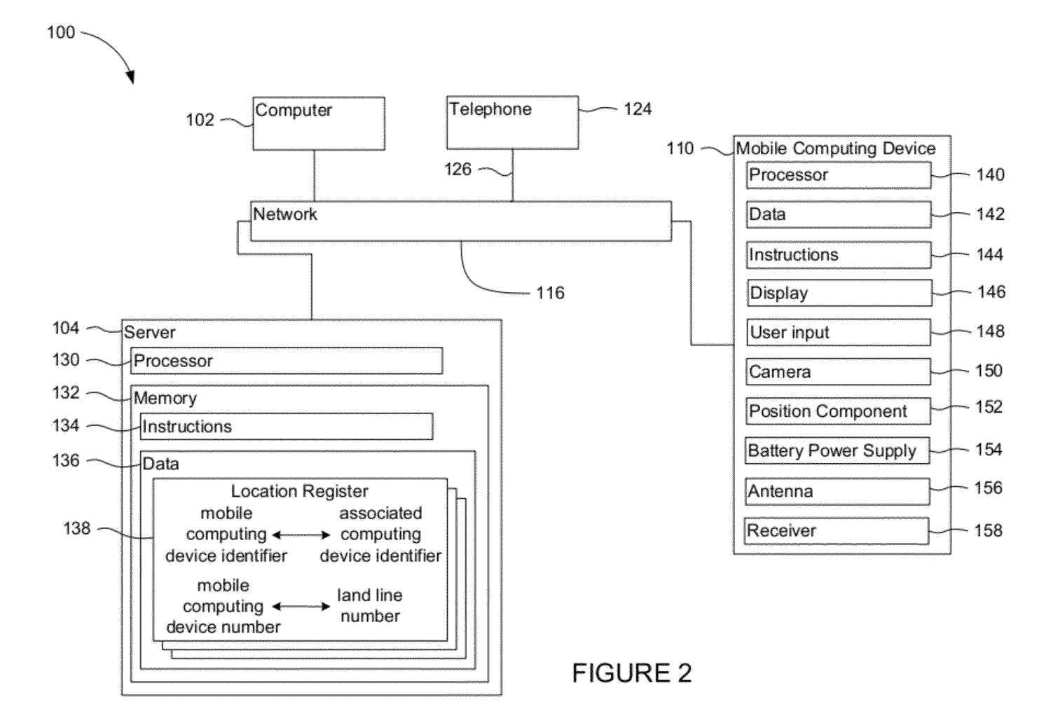

As shown in FIG. 2, the system 100 in accordance with example embodiments includes the computer 104 containing a processor 130, memory 132 and other components typically present in general purpose computers. The memory 132 stores information accessible by the processor 130, including instructions 134 and data 136 that may be executed or otherwise used by the processor 130. The memory 132 may be of any type capable of storing information accessible by the processor 130, including a computer-readable medium, or other medium that stores data that may be read with the aid of an electronic device, such as a hard-drive, memory card, flash drive, ROM, RAM, DVD or other optical disks, as well as other write-capable and read-only memories. In that regard, the memory 132 may include short term or temporary storage as well as long term or persistent storage. Systems and methods may include different combinations of the foregoing, whereby different portions of the instructions 134 and data 136 are stored on different types of media.

The instructions 134 may be any set of instructions to be executed directly (such as machine code) or indirectly (such as scripts) by the processor 130. For example, the instructions 134 may be stored as computer code on the computer-readable medium. In that regard, the terms “instructions” and “programs” may be used interchangeably herein. The instructions 134 may be stored in object code format for direct processing by the processor 130, or in any other computer language including scripts or collections of independent source code modules that are interpreted on demand or compiled in advance. Functions, methods and routines of the instructions 134 are explained in more detail below.

The data 136 may be retrieved, stored or modified by the processor 130 in accordance with the instructions 134. For instance, although the architecture is not limited by any particular data structure, the data 136 may be stored in computer registers, in a relational database as a table having a plurality of different fields and records, XML documents or flat files. The data 136 may also be formatted in any computer-readable format. By further way of example only, image data may be stored as bitmaps comprised of grids of pixels that are stored in accordance with formats that are compressed or uncompressed, lossless or lossy, and bitmap or vector-based, as well as computer instructions for drawing graphics. The data 136 may comprise any information sufficient to identify the relevant information, such as numbers, descriptive text, proprietary codes, references to data stored in other areas of the same memory or different memories (including other network locations) or information that is used by a function to calculate the relevant data. The data 136 of the computer 104 may include a location register 138, which is a database that maintains data about a current location of a mobile computing device (e.g., a home location register (HLR), a visitor location register (VLR), etc.). In accordance with aspects of the disclosure, the location register 138 may maintain a database devices associated with a mobile computing device. For example, the database may associate a unique identifier of a mobile computing device with an identifier of an associated computing device such that when the mobile computing device is detected to be within range of a particular wireless source, a particular application is caused to be executed on the associated computing device. In another example, the database may associate land line telephone numbers with mobile computing device telephone numbers such that calls intended for a mobile computing device may be redirected to the associated telephone connected to a land line, as described in detail below.

The processor 130 may be any conventional processor, such as a CPU. Alternatively, the processor 130 may be a dedicated controller such as an ASIC. Although FIG. 2 functionally illustrates the processor 130 and memory 132 as being within the same block, the processor 130 and memory 132 may actually comprise multiple processors and memories that may or may not be stored within the same physical housing. For example, the memory 132 may be a hard drive or other storage media located in a server farm of a data center. Accordingly, references to a processor, a computer or a memory will be understood to include references to a collection of processors or computers or memories that may or may not operate in parallel.

The computer 104 may be at one node of a network 116 and capable of directly and indirectly receiving data from other nodes of the network 116. For example, the computer 104 may comprise a web server that is capable of receiving data from mobile computing device 110 and telephone 124 via network 116 such that the server 104 uses the network 116 to transmit and display information to a user on display 146 of mobile computing device 110 or to transmit data to telephone 124. Server 104 may also comprise a plurality of computers that exchange information with different nodes of a network for the purpose of receiving, processing and transmitting data to the mobile computing device 110 and the telephone 124. In this instance, the mobile computing device 110 and the telephone 124 will typically still be at different nodes of the network than any of the computers comprising server 104.

The network 116, and intervening nodes between the computer 102, the server 104, the mobile computing device 110 and the telephone 124, may comprise various configurations and use various protocols including the Internet, World Wide Web, intranets, virtual private networks, local Ethernet networks, private networks using communication protocols proprietary to one or more companies, cellular and wireless networks (e.g., Wi-Fi), instant messaging, HTTP and SMTP, and various combinations of the foregoing. Although only a few computers are depicted in FIGS. 1 and 2, it should be appreciated that a typical system can include a large number of connected computers.

The mobile computing device 110 may include an antenna 156 and receiver 158 which may be used to scan the wireless network spectrum and identify local wireless network signals. For example, the antenna 156 may receive “beacon” messages and send them to the receiver 158 which demodulates the information to identify wireless network access points. In one example, these beacon messages may be IEEE 802.11 management frames transmitted by access points to announce themselves to potential wireless network users. These frames may contain Service Set Identifiers (“SSID”) information as well as physical layer parameters that assist devices in connecting to the wireless network. The beacon messages may also include additional network access information which also assists devices in accessing the network, including whether the access point is accepting new users, whether the data is encrypted, and which type of authentication is being used, for example, no authentication (open to all), password based, web-portable based, or Media Access Control (“MAC”) address based. However, data collected in accordance with this disclosure may be limited to the information discussed above, for example MAC addresses, SSIDs or other identifiers and signal strengths, and need not contain additional information. For example, information contained in the network traffic or payload data, such as personal information, need not be collected, and in fact, may actually be removed in order to protect the privacy of the wireless network's users.

Users may be required to take an affirmative step in order to select or “opt-in” to participate. For example, users may be required to sign-in to a service before providing any information and may be provided with an explanation of how and why their feedback is being used. Similarly, users may be provided with the opportunity to cease participation temporarily or permanently at any time. By requiring users to opt-in and sign-in for the service, this may also reduce the amount of third parties attempting to spam the system. Over time, the system may determine whether the data provided by some users' devices is consistently at odds with that of other users, and disregard the information provided by inconsistent devices.

Each mobile computing device 110 may be intended for use by a person and capable of wirelessly exchanging data, including position information derived from a geographical position component 152, with the server 104 over the network 116 such as the Internet. By way of example only, mobile computing device 110 may be a wireless-enabled PDA, a cellular phone, a netbook or a tablet PC capable of obtaining information via the Internet or other network. The user may input information using a small keyboard, a keypad, voice recognition or a touch screen.

The mobile computing device 110 has all of the components normally used in connection with mobile devices such as a central processing unit (CPU) 140, memory (e.g., RAM and internal hard drives) storing data 142 and instructions 144, an electronic display 146 (e.g., a monitor having a screen), and user input 148 (e.g., a keyboard or touch-screen).

The mobile computing device 110 may also include an image capturing device (e.g., a camera 150), the geographical position component 152, accelerometer, speakers, a network interface device, a battery power supply 154 or other power source, and all of the components used for connecting these elements to one another.

In addition to the operations described below and illustrated in the figures, various operations in accordance with example embodiments will now be described. It should also be understood that the following operations do not have to be performed in the precise order described below. Rather, various steps can be handled in a different order or simultaneously, and may include additional or fewer operations.

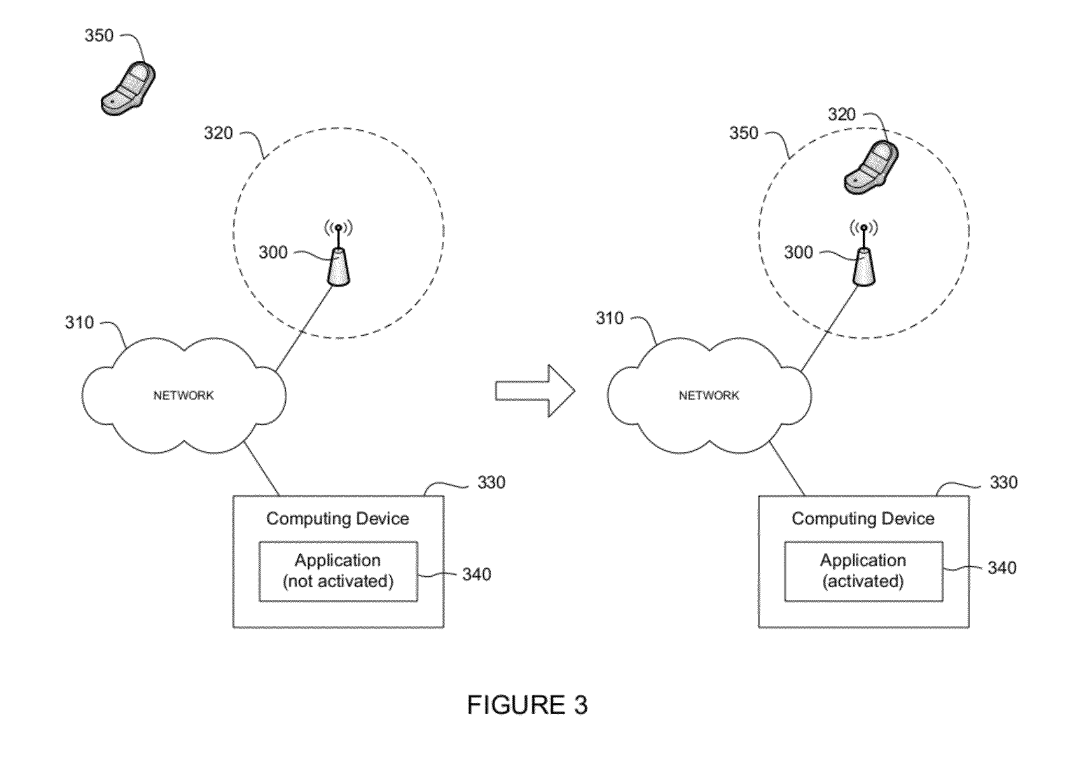

FIG. 3 is a pictorial diagram of a system in accordance with example embodiments. Referring to the left side of the diagram, the system includes a wireless access point 300 coupled to a network 310. The wireless network access point 300 emits a signal that is detected by mobile computing devices that are located within a predetermined range 320 of the wireless network access point 300.

A computing device 330 is also coupled to the network 310. An application 340 is stored on the computing device 330. The application 340 is associated with a mobile computing device 350 and a particular wireless access point such that when the mobile computing device 350 is within the predetermined range 320 of the wireless access point 300, the application 340 is activated (as shown in the right side of the diagram).

In one illustrative example, a user returns home after a day of capturing images using her mobile computing device. When the user's Wi-Fi network is detected by the user's mobile device, an application on the user's personal computer activates to transfer the images from the mobile computing device to the personal computer.

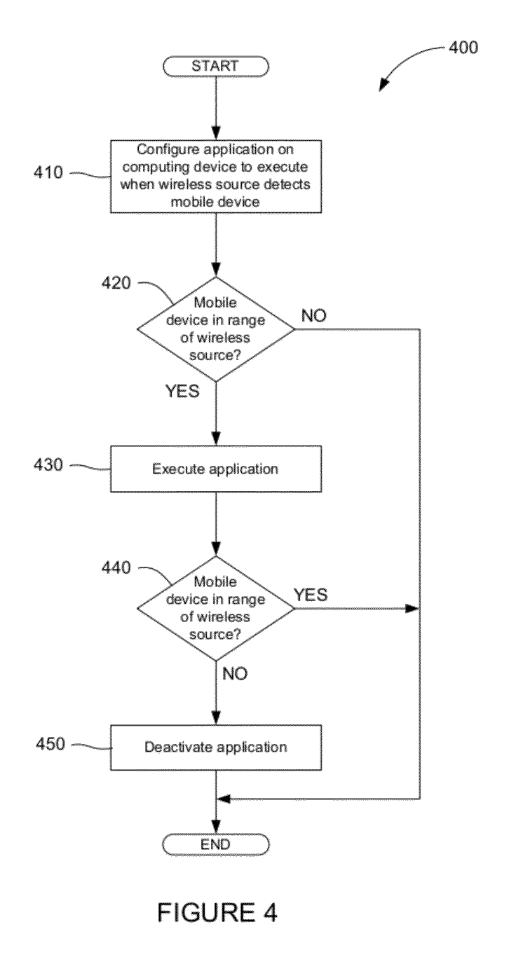

FIG. 4 demonstrates a process 400 of activating an application on a computing device when a mobile computing device is detected by a wireless source. For ease of description, the process 400 is described with reference to an application that, when activated, causes a light bulb to turn on. However, the application may be any network-based process that can be activated in response to a particular mobile device detecting a particular wireless source.

The process 400 begins when a user configures an application on a computing device to execute when a wireless source is detected by a particular mobile computing device (block 410). The computing device may be coupled to the wireless source via a network. The user may configure the application on the computing device by associating an identifier of the wireless source with an identifier of the mobile computing device. In some implementations, the user may define a signal strength threshold of the identified wireless sources that would be required at the mobile computing device to cause the application to execute. This feature allows the user to identify a specific geographic area where the presence of the mobile computing device will activate the application.

Using the light activation example, the user may configure the application to turn on a specific light (or lights) when the user's mobile computing device detects the wireless source. In one implementation, the lighting for a house may be centrally controlled by the computing device. This “smart home” feature typically allows occupants to control many electronic features of the home both locally and remotely.

A determination is made as to whether the mobile computing device is within a range of the corresponding wireless source (block 420). The determination may made by the mobile computing device continuously monitoring the presence of the corresponding wireless source. The wireless source, which may be a Wi-Fi network or a Bluetooth device, continually transmits a signal. If the mobile computing device does not detect the wireless source, processing is suspended; otherwise processing continues to block 430.

If the mobile computing device is within range of the wireless source, the application is executed on the computing device (block 430). When the wireless source is detected by the mobile computing device, the computing device on which the application is stored is activated to execute the application. For example, a “smart home” computing device executes an application that causes the corresponding light(s) to turn on.

In some implementations, the application may be configured to execute when the mobile computing device moves out of range of the wireless source. For example, a subsequent determination is made as to whether the mobile device is still within range of the wireless device (block 440). If the mobile device remains within range of the wireless source, processing is suspended; otherwise processing continues to block 450.

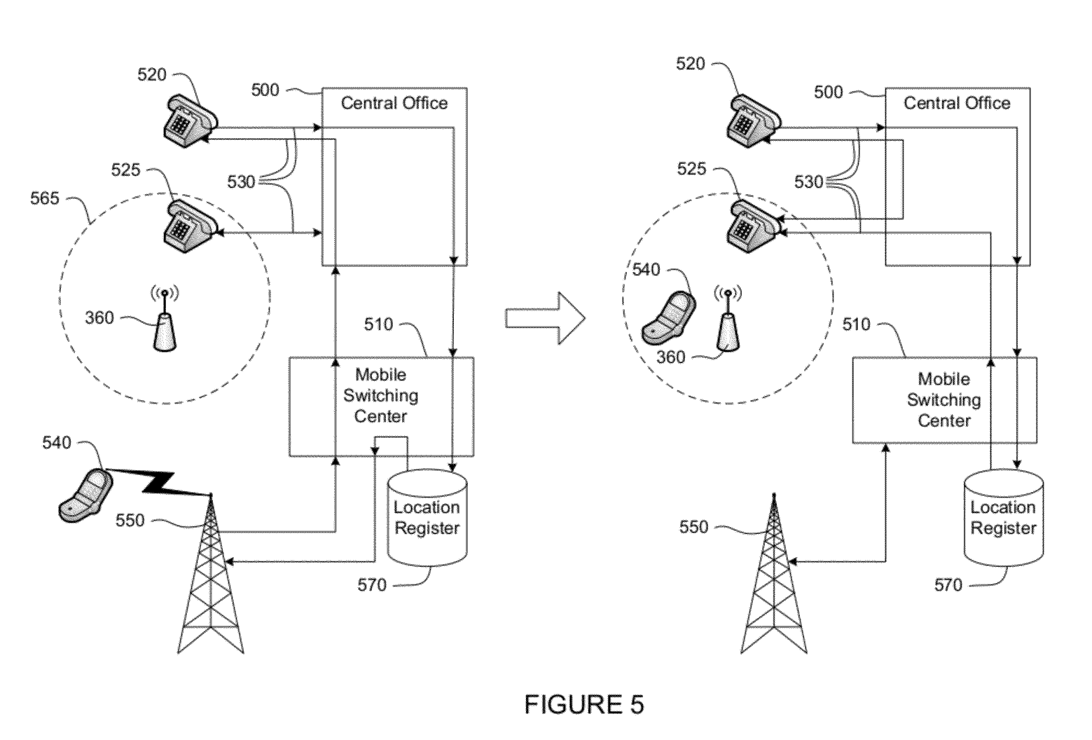

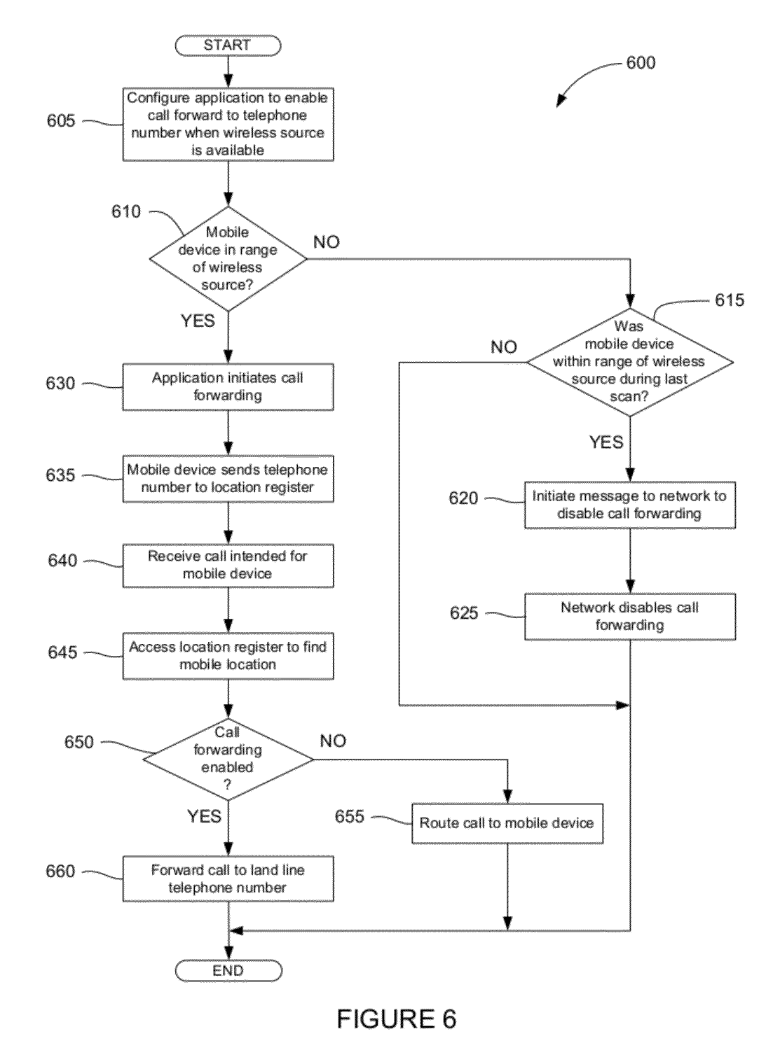

In the event that the mobile computing device is no longer within range of the wireless source, the application may be deactivated by the computing device (block 450). The user may configure the computing device to deactivate the application because the user's device is no longer within the targeted geographic area. For example, the mobile computing device may no longer be in the area illuminated by the light(s) that were turned on by the initial execution of the application. FIGS. 5 and 6 are used to illustrate a specific example of proximity-based application activation using a call forwarding application.

FIG. 5 is a pictorial diagram of a system for forwarding calls intended for a mobile computing device to a telephone connected to a land line. Referring to the left side of the diagram, the system includes a central telecommunications office 500 and a mobile switching center 510 coupled to the central telecommunications office 500. Telephones 520, 525 are coupled to the central telecommunications office 500 via a land line network 130. The mobile switching center 510 sends calls to mobile computing devices, such as mobile computing device 340, via base stations, such as base station 550.

A wireless network access point 560 is provided proximate at least one of the telephones 520, 525. The wireless network access point 560 emits a signal that is detected by mobile computing devices that are located within a predetermined range 565 of the wireless network access point 560. Examples of wireless sources include a Wi-Fi network or a Bluetooth device. A location register 570 is coupled to the mobile switching center 510. The location register may be a home location register (HLR), a visitor location register (VLR), or any other type of database that maintains data about a current location of a mobile computing device.

During normal operation, a user may place a call from the telephone 520 to the mobile computing device 540. The call is received from the telephone 520 at the central telecommunications office 500. The central telecommunications office 500 sends the call to the mobile switching center 310. The mobile switching center 510 accesses the location register 570 to determine the location of the mobile computing device 540. The mobile computing device 540 continually updates its location at the location register 570 such that the accessed location is the presumed current location of the mobile computing device 540. Once the location of the mobile computing device 540 is determined, the mobile switching center 510 pages the base stations in the vicinity of the location of the mobile computing device 540. The mobile computing device 340 responds to the page from the nearest base station. The mobile computing device 540 is then communicatively coupled to that base station 550 such that the user of the mobile computing device 540 may communicate with the user at the telephone 520.

The user may configure a call forwarding application on his mobile computing device such that calls to be received at the mobile computing device are redirected to the telephone 525 connected to the land line network 530. When the call forwarding feature is enabled, the location register 570 is updated with a telephone number that is associated with the telephone 525. Referring to the right side of FIG. 5, as the user moves around with the mobile computing device 540, the mobile computing device 540 may come within the range 565 of the wireless network access point 560. When the mobile computing device 540 comes within the range 165 of the wireless network access point 560, any calls intended for the mobile computing device 540 are redirected to the telephone 125 over the land line network 530.

In the above call forwarding situation, when a call is placed from the telephone 520 to the mobile computing device 540, the central telecommunications office 500 contacts the mobile switching center 510. The mobile switching center 510 accesses the location register 570 and determines that the call should be forwarded to the telephone 525 through the land line network 530. This determination is made based on the forwarding telephone number associated with the mobile computing device 540 that was stored in the location register 570 when the user configured the call forwarding application on the mobile computing device 540. The call is then forwarded to the telephone 525 such that the user of the telephone 525 may communicate with the user of the telephone 520 over the land line network 530. The call may also originate from a mobile computing device such that the call to a different mobile computing device may be redirected to a telephone connected to the land line network 530.

FIG. 6 demonstrates a process 600 of reducing the load on a cellular network by forwarding calls intended for a mobile computing device to a telephone coupled to a land line network. The process 600 begins when a user configures the call forwarding application on her mobile computing device to enable call forwarding from the mobile computing device to a telephone coupled to a land line (block 605). The telephone that is coupled to the land line is within the presence of a wireless source associated with a wireless source identifier (Y). The call forwarding application may be downloaded onto the mobile computing device, or the call forwarding application may be pre-installed on the mobile computing device. The user may configure the call forwarding application on the mobile computing device by associating the wireless source identifier (Y) with a telephone number (X) of the land line telephone to which the calls intended for the mobile computing device are to be forwarded. The user may also configure the call forwarding application on the mobile computing device to activate call forwarding when the mobile computing device is being used to conduct a different voice call or when the mobile computing device is located in an area that lacks wireless network coverage. The wireless source may be a source that is detectable in the vicinity of the associated telephone. In some embodiments, the user may configure the call forwarding application on the mobile computing device such that multiple wireless source identifiers are associated with different land line telephone numbers. The user may also define a signal strength threshold of the identified wireless sources that would be required at the mobile computing device to activate call forwarding. This feature allows the user to identify a specific geographic area where call forwarding is enabled.

A determination is made whether the mobile computing device is within a range of the wireless source associated with wireless identifier (Y) that is proximate the telephone connected to the land line having telephone number (X) to which any calls are to be forwarded (block 610). The determination is made by the mobile computing device continuously monitoring the presence of the pre-identified wireless source. The wireless source, which may be a Wi-Fi network or a Bluetooth device, continually transmits a signal in the vicinity of the landline telephone. The call forwarding application installed on the mobile computing device continuously monitors the signal from the wireless source. If the mobile computing device is not within range of the wireless source, processing proceeds to block 615; otherwise processing continues to block 630.

At block 615, a determination is made as to whether the mobile computing device was within range of the wireless source (Y) during the previous scan. If the mobile computing device was not within range of the wireless source (Y) during the previous scan, processing terminates. In the event that the mobile computing device was within range of the wireless source (Y) during the previous scan but subsequently moved out of range, processing continues to block 620 where the application initiates a message to the network to disable call forwarding. In response to the message, the network disables call forwarding (block 625).

If the mobile computing device is within range of the wireless source, processing continues to block 630 where the application initiates call forwarding. When the call forwarding application detects the presence of the predefined wireless source signal and at a predefined signal strength level, the application automatically enables call forwarding by sending a message to the cellular network that includes the call forward number (X) where all calls are to be forwarded. As a result, any voice calls intended for the mobile computing device will be forwarded to the corresponding telephone connected to the land line.

The telephone number (X) of the telephone connected to the land line where the calls are to be forwarded is sent from the mobile computing device to the cellular network and is stored in a location register (e.g., HLR or VLR) (block 635).

The mobile switching center subsequently receives a call intended for the mobile computing device (block 640). The call may be made from a different mobile computing device or from a telephone connected to the land line network. The mobile switching center accesses the location register to determine the number of the land line connected telephone to which the call should be forwarded (block 645).

A determination is made as to whether the call forwarding application is enabled (block 650). If call forwarding is not enabled, processing proceeds to bock 655 where the call is routed to the intended mobile computing device.

In the event that call forwarding is enabled, processing continues to block 660 where the call is forwarded from the mobile switching center to the identified telephone connected to the land line network (block 660). The cellular network may then confirm that the call was forwarded to the designated telephone. Processing then terminates. By removing voice calls from the cellular network, the load on the cellular network is reduced because voice traffic over the air interface in the cellular network is minimized.

As described above with reference to FIGS. 5 and 6, a user may have calls intended for a mobile computing device forwarded to a telephone connected to a land line. The user may wish to receive calls on the land line telephone because reception is clearer and the cost of using the land line telephone may be lower than using the mobile computing device. The user may also wish to receive calls on the land line telephone to conserve mobile computing device battery power and to promote convenience by receiving all calls at one telephone. By directing data from the cellular network to the land line network, the load on the cellular network is reduced and traffic on cellular network will decrease.

As these and other variations and combinations of the features discussed above can be utilized without departing from the scope of the claims, the foregoing description of exemplary embodiments should be taken by way of illustration rather than by way of limitation. For example, the proximity-based decisions are described with reference to telephone calls being forwarded from a mobile device to a land line telephone. However, the disclosure can be interpreted to include the forwarding of any type of media including emails, text messages, videos or other actions and applications on a mobile computing device or mobile network. It will also be understood that the provision of examples (as well as clauses phrased as “such as,” “e.g.”, “including” and the like) should not be interpreted as limiting; rather, the examples are intended to illustrate only some of many possible aspects.

1. A computer-implemented method comprising:
identifying a location of a mobile computing device within range of a wireless source;
receiving a message from the mobile computing device, wherein the message comprises a land line telephone number where voice calls are to be forwarded; and
forwarding a voice call intended for the mobile computing device to a telephone coupled to a land line network based on the land line telephone number.

2. The method of claim 1, further comprising:
storing the land line telephone number and a number of the mobile computing device in a location register, wherein the land line telephone number is associated with the number of the mobile computing device in the location register.

3. The method of claim 2, further comprising:
accessing the location register to identify the land line telephone number using the number of the mobile computing device.

4. The method of claim 1, wherein the telephone is located within range of the wireless source, the land line telephone number being associated with an identifier of the wireless source.

5. The method of claim 4, wherein a signal strength received by the mobile computing device from the wireless source exceeds a predetermined threshold.

6. The method of claim 1, wherein the voice call originates from a different mobile computing device.

7. The method of claim 1, wherein the voice call originates from a different telephone coupled to the land line network.

8. A mobile computing device comprising a processor configured to execute a call forwarding application, the executed call forwarding application causing the processor to:
identify that the mobile computing device is within range of a wireless source; and
send a message to a location register, wherein the message comprises a land line telephone number where a voice call intended for the mobile computing device is to be forwarded.

9. The mobile computing device of claim 8, wherein the land line telephone number is associated with an identifier of the wireless source.

10. The mobile computing device of claim 8, wherein the voice call is forwarded to the land line telephone number in the event that a signal strength received by the mobile computing device from the wireless source exceeds a predetermined threshold.

11. The mobile computing device of claim 8, wherein the voice call originates from a different mobile computing device.

12. The mobile computing device of claim 8, wherein the voice call originates from a telephone coupled to a land line network.

13. A system comprising:
a telephone coupled to a central telecommunications office by a land line network; and
a mobile computing device coupled to a mobile switching center by a base station, the mobile computing device being positioned within range of a wireless source provided proximate the telephone, wherein the mobile switching center is coupled to the central telecommunications office and the mobile switching center comprises a location register, the location register associating a first number identifying the telephone with a second number identifying the mobile computing device,
wherein a voice call directed to the mobile computing device at the second number is redirected to the telephone at the first number.

14. The system of claim 13, wherein the mobile switching center receives a message from the mobile computing device, wherein the message comprises the first number.

15. The system of claim 13, wherein the location register is accessed to identify the first number to which the voice call is redirected.

16. The system of claim 13, wherein the telephone is located within range of the wireless source, the first number being associated with an identifier of the wireless source.

17. A computer-implemented method comprising:
receiving, at a computing device, a signal from a wireless source that a mobile computing device is within range of the wireless source, wherein the signal comprises an identifier of the mobile computing device and an identifier of the wireless source;
identifying an application associated with the mobile computing device and the wireless source, wherein the application is stored on the computing device and is identified using the identifier of the mobile computing device and the identifier of the wireless source; and
executing the application on the computing device.

18. The method of claim 17, wherein the executing application causes data stored on the mobile computing device to be transferred to the computing device.

19. The method of claim 17, further comprising:
receiving, at the computing device, a signal from the wireless source that the mobile computing device is not in range of the wireless source; and
ceasing execution of the application.
